(19) United States
(12) Patent Application Publication
(10) Pub. No.: US 2024/0152804 A1
(43) Pub. Date: May 9, 2024

(54) COMPATIBILITY EVALUATION DEVICE, COMPATIBILITY EVALUATION METHOD, AND RECORDING MEDIUM

(71) Applicant: NEC Corporation, Minato-ku, Tokyo (JP)

(72) Inventor: Tomoya Sakai, Tokyo (JP)

(73) Assignee: NEC Corporation, Minato-ku, Tokyo (JP)

(21) Appl. No.: 18/279,493

(22) PCT Filed: Mar. 3, 2021
(86) PCT No.: PCT/JP2021/008149

§ 371 Date: Aug. 30, 2023

(51) Int. Cl. G06N 20/00

(52) U.S. Cl. CPC G06N 20/00

(57) ABSTRACT

In a compatibility evaluation device, the acquisition means acquires outputs of a first predictor and a second predictor for evaluation data. The index determination means determines a generalized backward compatibility index defined by a combination of a plurality of relational expressions representing relationship between the output of the first predictor and the output of the second predictor. The calculation means calculates a score indicating compatibility of the first predictor and the second predictor, using the output of the first predictor, the output of the second predictor, and the generalized backward compatibility index.

### TECHNICAL FIELD

The present disclosure relates to a technique for evaluating predictors.

### BACKGROUND ART

In the operation of AI (Artificial Intelligence), in order to adapt and improve the performance of AI against environmental changes, it is essential to perform relearning using new data and update AI. When updating AI, it is required that the accuracy of AI after the updating be improved from the AI before the updating. Patent Document 1 discloses a method for reducing the deterioration of a model when updating a model generated by machine learning. Further, Patent Document 2 discloses a technique for evaluating the closeness of the structures of the prediction models before and after the relearning as the closeness of the nature of the prediction models.

### PRECEDING TECHNICAL REFERENCES

### Patent Document

Patent Document 1: Japanese Patent Application Laid-Open under No. 2019-204190
Patent Document 2: International Publication WO2016/151618

### SUMMARY

### Problem to be Solved

Even when the accuracy is improved by updating AI, the behavior of AI may differ before and after the updating. For example, there may occur such a phenomenon that the AI after the updating cannot correctly answer the question that the AI before the updating answered correctly. In this situation, AI operators may need to spend much effort and time to grasp the habits of AI after the updating, or they may need to change business operations for the prediction by AI.

It is an object of the present disclosure to provide a technique for evaluating compatibility of predictors.

### Means for Solving the Problem

According to an example aspect of the present disclosure, there is provided a compatibility evaluation device comprising:
an acquisition means configured to acquire outputs of a first predictor and a second predictor for evaluation data;
an index determination means configured to determine a generalized backward compatibility index defined by a combination of a plurality of relational expressions representing relationship between the output of the first predictor and the output of the second predictor; and
a calculation means configured to calculate a score indicating compatibility of the first predictor and the second predictor, using the output of the first predictor, the output of the second predictor, and the generalized backward compatibility index.

According to another example aspect of the present disclosure, there is provided a compatibility evaluation method comprising:
acquiring outputs of a first predictor and a second predictor for evaluation data;
determining a generalized backward compatibility index defined by a combination of a plurality of relational expressions representing relationship between the output of the first predictor and the output of the second predictor; and
calculating a score indicating compatibility of the first predictor and the second predictor, using the output of the first predictor, the output of the second predictor, and the generalized backward compatibility index.

According to still another example aspect of the present disclosure, there is provided a recording medium storing a program, the program causing a computer to:
acquire outputs of a first predictor and a second predictor for evaluation data;
determine a generalized backward compatibility index defined by a combination of a plurality of relational expressions representing relationship between the output of the first predictor and the output of the second predictor; and
calculate a score indicating compatibility of the first predictor and the second predictor, using the output of the first predictor, the output of the second predictor, and the generalized backward compatibility index.

### Effect

According to the present disclosure, the compatibility of the predictors can be evaluated.

### BRIEF DESCRIPTION OF THE DRAWINGS

FIG. 1 shows examples of prediction results by a pre-update AI and a post-update AI for evaluation data.

FIG. 2 is a block diagram showing an overall configuration of a compatibility evaluation device according to a first example embodiment.

FIG. 3 is a block diagram showing a hardware configuration of the compatibility evaluation device according to the first example embodiment.

FIG. 4 is a block diagram showing a functional configuration of the compatibility evaluation device according to the first example embodiment.

FIG. 5 is a flowchart of compatibility evaluation processing of the first example embodiment.

FIG. 6 is a block diagram showing a functional configuration of a compatibility evaluation device according to a second example embodiment.

FIG. 7 is a flowchart of processing by the compatibility evaluation device according to the second example embodiment.

### EXAMPLE EMBODIMENTS

Preferred example embodiments of the present disclosure will be described with reference to the accompanying drawings.

<Compatibility Evaluation Index>

(Compatibility of Predictors)

When AI is updated (relearned) using new data, the update is carried out so that the accuracy may be improved. At that time, the compatibility of AI becomes an issue. Compatibility refers to the degree of coincidence between the correct/incorrect answers of the pre-update AI and the correct/incorrect answers of the post-update AI.

One of the indices showing compatibility is a Backward Trust Compatibility (hereafter referred to as “BTC”) score. The BTC score is a percentage that the post-update AI can correctly answer the data that the pre-update AI correctly answered. When the BTC score is high, compatibility is high.

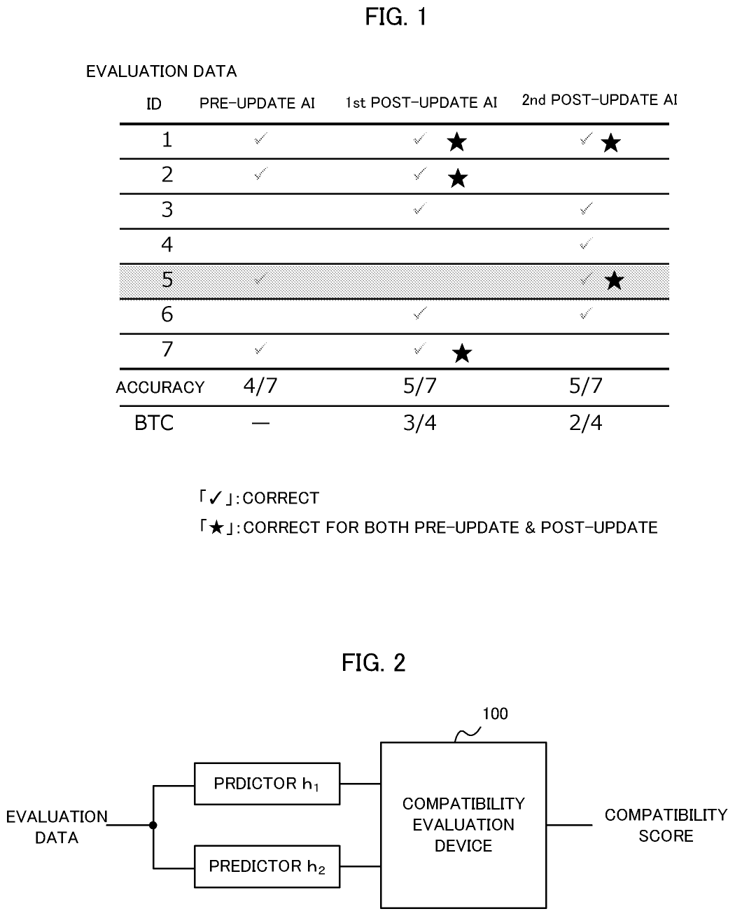

FIG. 1 shows examples of prediction results that a pre-update AI and two post-update AI output for evaluation data. The pre-update AI is an AI currently in operation. The two post-update AI are AI obtained by relearning the pre-update AI, but they are different AI generated by changing the hyperparameters, etc. In FIG. 1, a check mark (✓) indicates that the prediction result is correct.

As shown in FIG. 1, the pre-update AI correctly answered four of the evaluation data 1 to 7, and its accuracy is 4/7. In contrast, both the first post-update AI and the second post-update AI have an accuracy of 5/7, which is better than the pre-update AI. On the other hand, the first post-update AI correctly answered the three evaluation data indicated by the star marks (★) out of the four evaluation data that the pre-update AI correctly answered, and the BTC score is 3/4. In contrast, the second post-update AI correctly answered only two of the four evaluation data that the pre-update AI correctly answered, and the BTC score is 2/4. Therefore, although the two post-update AI have the same accuracy, it is evaluated that the first post-update AI with high compatibility (BTC score) is better.

Another index of compatibility is a Backward Error Compatibility (hereinafter referred to as “BEC”) score. The BEC score is a percentage that the pre-update AI mistakes data that the post-update AI mistakes. When the BEC is high, the compatibility is high.

Thus, when updating AI by relearning, not only accuracy but also compatibility with the pre-update AI must be considered. In the following, we propose a generalized backward compatibility index that can be applied to various tasks.

(Generalized Backward Compatibility Index)

The generalized backward compatibility index is an index which generalized the compatibility index such as the aforementioned BTC and BEC. Examples of the generalized backward compatibility index are described below.

### First Example

The first example is an example of the most basic generalized backward compatibility index. It is assumed that a predictor h and a pair of an input and an output are as follows.
PREDICTOR: h: X→y
PAIR OF INPUT/OUTPUT: (X,Y) ∈X×Y
   Then, the generalized backward compatibility (Generalized Backward Compatibility; GBC) score of the first example is defined by a linear fractional index as follows.

$$GBC ( {h}_{1} , {h}_{2} ) = \frac{\begin{matrix}{a}_{0} + {a}_{00} EC ( {h}_{1} , {h}_{2} ) + {a}_{01} {IC}_{1} ( {h}_{1} , {h}_{2} ) + \\ {a}_{10} {IC}_{2} ( {h}_{1} , {h}_{2} ) + {a}_{11} CC ( {h}_{1} , {h}_{2} )\end{matrix}}{\begin{matrix}{b}_{0} + {b}_{00} EC ( {h}_{1} , {h}_{2} ) + {b}_{01} {IC}_{1} ( {h}_{1} , {h}_{2} ) + \\ {b}_{10} {IC}_{2} ( {h}_{1} , {h}_{2} ) + {b}_{11} CC ( {h}_{1} , {h}_{2} )\end{matrix}} \qquad ( 1 )$$

The above Equation (1) includes four relational expressions CC(h₁,h₂), EC(h₁,h₂), IC₁(h₁,h₂), IC₂(h₁, h₂) that show the relation between the output of the predictor h₁ and the output of the predictor h₂ for the evaluation data. Each of “a₀”, “a₀₀”, “a₀₁”, “a₁₀”, “a₁₁”, “b₀”, “b₀₀”, “b₀₁”, “b₁₀”, “b₁₁” are a coefficient (weight).

The four relational expressions have the following meanings:
CC (Correct Compatibility) (h₁,h₂) indicates a ratio of the evaluation data, for which the predictor h₁ outputs a correct answer and the predictor h₂ outputs a correct answer, to all the evaluation data.
EC (Error Compatibility) (h₁,h₂) indicates a ratio of the evaluation data, for which the predictor h₁ outputs an incorrect answer and the predictor h₂ outputs an incorrect answer, to all the evaluation data.
IC₁ (Imcompatibility-1) (h₁,h₂) indicates a ratio of the evaluation data, for which the predictor h₁ outputs an correct answer and the predictor h₂ outputs an incorrect answer, to all the evaluation data.
IC₂ (Imcompatibility-2) (h₁,h₂) indicates a ratio of the evaluation data, for which the predictor h₁ outputs an incorrect answer and the predictor h₂ outputs a correct answer, to all the evaluation data.

Specifically, the above four relational expressions are given as follows.

$$CC ( {h}_{1} , {h}_{2} ) = {𝔼}_{XY} [ [ {h}_{1} ( X ) = Y , {h}_{2} ( X ) = Y ] ] \qquad ( 2 )$$

$$EC ( {h}_{1} , {h}_{2} ) = {𝔼}_{XY} [ [ {h}_{1} ( X ) \neq Y , {h}_{2} ( X ) \neq Y ] ] \qquad ( 3 )$$

$${IC}_{1} ( {h}_{1} , {h}_{2} ) = {𝔼}_{XY} [ [ {h}_{1} ( X ) \neq Y , {h}_{2} ( X ) = Y ] ] \qquad ( 4 )$$

$${IC}_{2} ( {h}_{1} , {h}_{2} ) = {𝔼}_{XY} [ [ {h}_{1} ( X ) = Y , {h}_{2} ( X ) \neq Y ] ] \qquad ( 5 )$$

$${𝔼}_{XY} is expected value of ( X , Y )$$

$$[ cond ] = \{ \begin{matrix}1 & if cond is true \\ 0 & otherwise\end{matrix}$$

In Equation (1), when the coefficients a₁₁, b₁₀, b₁₁ are set to “1” and the other coefficients are set to “0,” the GBC score of Equation (1) matches the BTC score. Thus, the above GBC includes the BTC.

Further, in Equation (1), when the coefficients a₀₀, b₀₀, b₁₀ are set to “1” and the other coefficients are set to “0”, the GBC score in Equation (1) matches the BEC score. Thus, the above GBC includes the BEC.

Thus, by utilizing the above generalized backward compatibility index (GBC), an appropriate compatibility index can be defined according to the task of the predictor by changing the coefficients (weights) of Equation (1).

Next, an example of the equation for calculating the score using GBC of the first example is shown. Now, the inputs are set as follows.
Two predictors for evaluating compatibility: h₁, h₂

$$Evaluation data : {\{ ( {x}_{i} , {y}_{i} ) \}}_{i = 1}^{n}$$

$$Weights set : \begin{matrix}{a}_{0} , {a}_{00} , {a}_{01} , {a}_{10} , {a}_{11} \\ {b}_{0} , {b}_{00} , {b}_{01} , {b}_{10} , {b}_{11}\end{matrix}$$

The estimated value GBC A of the GBC score is given by the following equation. For convenience, the symbol with “\hat{ }” on the letter “X” is referred to as “X\hat{ }”.

$$\hat{GBC} ( {h}_{1} , {h}_{2} ) = \frac{\begin{matrix}{a}_{0} + {a}_{00} \hat{EC} ( {h}_{1} , {h}_{2} ) + {a}_{01} {\hat{IC}}_{1} ( {h}_{1} , {h}_{2} ) + \\ {a}_{10} {\hat{IC}}_{2} ( {h}_{1} , {h}_{2} ) + {a}_{11} \hat{CC} ( {h}_{1} , {h}_{2} )\end{matrix}}{\begin{matrix}{b}_{0} + {b}_{00} \hat{EC} ( {h}_{1} , {h}_{2} ) + {b}_{01} {\hat{IC}}_{1} ( {h}_{1} , {h}_{2} ) + \\ {b}_{10} {\hat{IC}}_{2} ( {h}_{1} , {h}_{2} ) + {b}_{11} \hat{CC} ( {h}_{1} , {h}_{2} )\end{matrix}} \qquad ( 6 )$$

The relational expressions CC\hat{ }, EC\hat{ }, IC₁\hat{ }, IC₂\hat{ } are given by the following equations, by replacing the expected value in Equations (2) to (5) with the sample mean.

$$\hat{CC} ( {h}_{1} , {h}_{2} ) = \frac{1}{n} {\sum }_{i = 1}^{n} [ {h}_{1} ( {x}_{i} ) = {y}_{i} , {h}_{2} ( {x}_{i} ) = {y}_{i} ] \qquad ( 7 )$$

$$\hat{EC} ( {h}_{1} , {h}_{2} ) = \frac{1}{n} {\sum }_{i = 1}^{n} [ {h}_{1} ( {x}_{i} ) \neq {y}_{i} , {h}_{2} ( {x}_{i} ) \neq {y}_{i} ] \qquad ( 8 )$$

$${\hat{IC}}_{1} ( {h}_{1} , {h}_{2} ) = \frac{1}{n} {\sum }_{i = 1}^{n} [ {h}_{1} ( {x}_{i} ) \neq {y}_{i} , {h}_{2} ( {x}_{i} ) = {y}_{i} ] \qquad ( 9 )$$

$${\hat{IC}}_{2} ( {h}_{1} , {h}_{2} ) = \frac{1}{n} {\sum }_{i = 1}^{n} [ {h}_{1} ( {x}_{i} ) = {y}_{i} , {h}_{2} ( {x}_{i} ) \neq {y}_{i} ] \qquad ( 10 )$$

### Second Example

In the first example described above, as shown in Equation (1), the coefficients (weights) are set for the four relational expressions CC, EC, IC₁, IC₂. In contrast, in the second example, the coefficients (weights) are set for each class y predicted by the predictors h₁ and h₂. The GBC score according to the second example is given by the following equation.

$$GBC ( {h}_{1} , {h}_{2} ) = \frac{\begin{matrix}{a}_{0} + CC ( {h}_{1} , {h}_{2} ; {a}_{11} ) + EC ( {h}_{1} , {h}_{2} ; {a}_{00} ) + \\ {IC}_{1} ( {h}_{1} , {h}_{2} ; {a}_{01} ) + {IC}_{2} ( {h}_{1} , {h}_{2} ; {a}_{10} )\end{matrix}}{\begin{matrix}{b}_{0} + CC ( {h}_{1} , {h}_{2} ; {b}_{11} ) + EC ( {h}_{1} , {h}_{2} ; {b}_{00} ) + \\ {IC}_{1} ( {h}_{1} , {h}_{2} ; {b}_{01} ) + {IC}_{2} ( {h}_{1} , {h}_{2} ; {b}_{10} )\end{matrix}} \qquad ( 11 )$$

In addition, the four relational expressions are given as follows.

$$CC ( {h}_{1} , {h}_{2} ; {a}_{11} ) = {\sum }_{y ∈ 𝒴} {a}_{11 , y} {𝔼}_{XY} [ [ {h}_{1} ( X ) = y , {h}_{2} ( X ) = y , Y = y ] ] \qquad ( 12 )$$

$$EC ( {h}_{1} , {h}_{2} ; {a}_{00} ) = {\sum }_{y ∈ 𝒴} {a}_{00 , y} {𝔼}_{XY} [ [ {h}_{1} ( X ) \neq y , {h}_{2} ( X ) \neq y , Y = y ] ] \qquad ( 13 )$$

$${IC}_{1} ( {h}_{1} , {h}_{2} ; {a}_{01} ) = {\sum }_{y ∈ 𝒴} {a}_{01 , y} {𝔼}_{XY} [ [ {h}_{1} ( X ) \neq y , {h}_{2} ( X ) = y , Y = y ] ] \qquad ( 14 )$$

$${IC}_{2} ( {h}_{1} , {h}_{2} ; {a}_{10} ) = {\sum }_{y ∈ 𝒴} {a}_{10 , y} {𝔼}_{XY} [ [ {h}_{1} ( X ) = y , {h}_{2} ( X ) \neq y , Y = y ] ] \qquad ( 15 )$$

$$* Similarly defined for denominators$$

Incidentally, if the weights are set to be constant such as a₁₁=a_{11,1}= . . . =a_{11,|y|}, the Equation (11) matches the Equation (1) of the first example.

The second GBC enables to construct a variety of pre-existing binary classifiers, which can be expressed in linear fractional expressions, in the context of backward compatibility. For example, the weights of the GBC shown in Equation (11) can be adjusted to construct a compatibility index that is effective for imbalanced binary classification. If the compatibility is not considered, the F-value (Y=1 is positive class and Y=0 is negative class) in the binary classification Y∈{0,1} are as follows:

$$\begin{matrix}F ( {h}_{1} ) = \frac{2 TP ( {h}_{1} )}{2 TP ( {h}_{1} ) + FP ( {h}_{1} ) + FN ( {h}_{1} )} \\ = \frac{2 {𝔼}_{XY} [ [ {h}_{1} ( X ) = 1 , Y = 1 ] ]}{\begin{matrix}2 {𝔼}_{XY} [ [ {h}_{1} ( X ) = 1 , Y = 1 ] ] + {𝔼}_{XY} [ [ {h}_{1} ( X ) = 1 , Y = 0 ] ] + \\ {𝔼}_{XY} [ [ {h}_{1} ( X ) = 0 , Y = 1 ] ]\end{matrix}}\end{matrix} \qquad ( 16 )$$

This F-value is an index of the accuracy in the imbalanced binary classification, which emphasizes the positive class with less data.

On the other hand, the F-value (referred to as “BC-F”) considering the compatibility is as follows when a_{11,1},=b_{11,1}=2, b_{11,0}=b_{00,1}=1 and the remaining factors are “0” in the GBC.

$$BC - F ( {h}_{1} , {h}_{2} ) = \frac{2 𝔼 [ [ {h}_{1} ( X ) = 1 , {h}_{2} ( X ) = 1 , Y = 1 ] ]}{\begin{matrix}2 𝔼 [ [ {h}_{1} ( X ) = 1 , {h}_{2} ( X ) = 1 , Y = 1 ] ] + 𝔼 [ [ {h}_{1} ( X ) = \\ 1 , {h}_{2} ( X ) = 1 , Y = 0 ] ] + 𝔼 [ [ {h}_{1} ( X ) = 0 , {h}_{2} ( X ) = 0 , Y = 1 ] ]\end{matrix}} \qquad ( 17 )$$

This BC-F value is an index of compatibility in imbalanced binary classification, which emphasizes the positive class with less data. Thus, by adjusting the weights of the GBC, compatibility indices in various binary classifications can be generated.

### Third Example

The third example is an example of a compatibility index other than the linear fractional expression such as the first example and the second example. In the binary classification, we consider the task in which the score ranking of the pre-update predictor coincides with the score ranking of the the post-update predictor. Assuming that the predictor assigns real numbers to “−1” or “+1,” the following compatibility index is obtained.
PRIDICTOR: h(X)=sign (g(X)) g: X→R
CLASS: y={−1, +1}
EXAMPLE OF COMPATIBILITY INDEX:

$${𝔼}_{X \vert Y = 1} [ {𝔼}_{X \vert Y = - 1} [ [ {g}_{1} ( X ) > {g}_{1} ( {X}^{′} ) ] [ {g}_{2} ( X ) > {g}_{2} ( {X}^{′} ) ] ] ] \qquad ( 18 )$$

This compatibility index includes a relational expression

1|g₁(X)>g₁(X′)┘

showing the magnitude relation of the output of the pre-update predictor and a relational expression

1[g₂(X)>g₂(X′)|┘

showing the magnitude relation of the output of the post-update predictor, when the evaluation data X whose correct answer is “+1” and the evaluation data X′ whose correct answer is “−1” are inputted. By this compatibility index, an expected value that the magnitude relation of the outputs to X′ and X before the update is maintained after the update can be obtained as the GBC score. In other words, the GBC score indicates whether or not the output tendency of the predictor before and after the update for the input matches. By this compatibility index, the effect like AUC (Area under the ROC curve) is expected.

(Application to Regression Tasks)

In the first and second examples described above, the predictor is assumed to perform a classification task. However, the GBC can also be applied to the predictor performing a regression task. In that case, the GBC of the first example or the second example may be applied by regarding the expected value as a correct answer if the difference between the expected value that the predictor outputs for the evaluation data and the actual value corresponding to the evaluation data is equal to or smaller than a predetermined threshold value, and regard the expected value as an incorrect answer if the difference is larger than the predetermined threshold value.

### First Example Embodiment

[Overall Configuration]

FIG. 2 is a block diagram showing an overall configuration of a compatibility evaluation device according to a first example embodiment. The compatibility evaluation device 100 evaluates the compatibility of the two predictors and outputs a compatibility score. As illustrated, identical evaluation data is inputted to the two predictors h₁, h₂. In a typical example, the predictor h₁ is the predictor currently in operation, i.e., the pre-update predictor, and the predictor h₂ is the post-update predictor.

The predictor h₁ and the predictor h₂ output the predicted value for the inputted evaluation data to the compatibility evaluation device 100. The compatibility evaluation device 100 uses the generalized backward compatibility index (GBC) described above to output the compatibility score indicating the compatibility between the output of the predictor h₁ and the output the predictor h₂.

[Hardware Configuration]

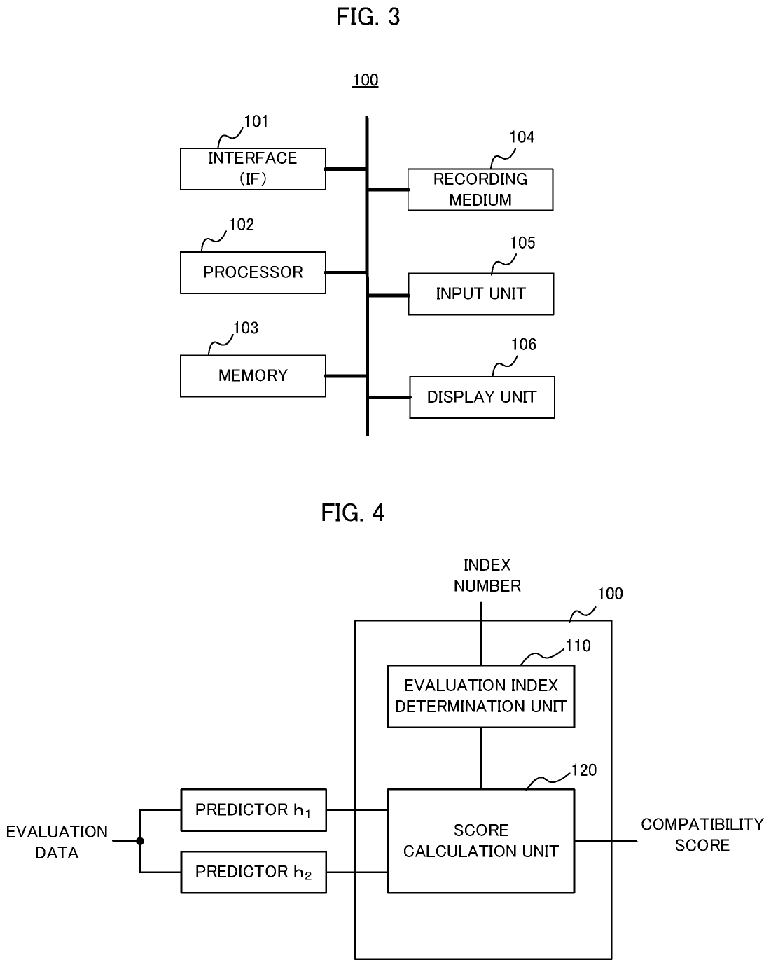

FIG. 3 is a block diagram showing a hardware configuration of the compatibility evaluation device 100. The compatibility evaluation device 100 includes an interface 101, a processor 102, a memory 103, a recording medium 104, an input unit 105, and a display unit 106.

The interface (IF) 101 receive the predicted values from the predictors h₁, h₂. The IF 101 outputs the compatibility score calculated by the compatibility evaluation device 100 to an external device. The IF 101 is an example of an acquisition means.

The processor 102 is a computer, such as a CPU, and controls the entire compatibility evaluation device 100 by executing a program prepared in advance. The processor 102 may be a GPU or an FPGA (Field-Programmable Gate Array). Specifically, the processor 102 performs the compatibility evaluation processing described below.

The memory 103 may be a ROM (Read Only Memory), a RAM (Random Access Memory), and the like. The memory 103 stores information of the generalized backward compatibility index, the coefficients (weights) for each index number, and the like. The memory 103 is also used as a working memory during various processing operations by the processor 102.

The recording medium 104 is a non-volatile and non-transitory recording medium such as a disk-like recording medium, a semiconductor memory, or the like, and is configured to be detachable from the compatibility evaluation device 100. The recording medium 104 records various programs executed by the processor 102. When the compatibility evaluation device 100 executes the processing, the program recorded in the recording medium 104 is loaded into the memory 103 and executed by the processor 102.

The input unit 105 may be, for example, a keyboard, mouse, or the like, and is used by a user to perform various instructions and inputs. The display unit 106 is, for example, a liquid crystal display device, and displays various types of information to the user.

[Functional Configuration]

FIG. 4 is a block diagram showing a functional configuration of the compatibility evaluation device 100. The compatibility evaluation device 100 functionally includes an evaluation index determination unit 110, and a score calculation unit 120. To the evaluation index determination unit 110, the index number is inputted. The index number designates the compatibility index used to evaluate the compatibility. The index number is determined based on, for example, the task of the predictor to be updated. Based on the inputted index number, the evaluation index determination unit 110 determines the compatibility index (GBC) to be used in actual evaluation (hereinafter, also referred to as “evaluation index”) based on the generalized backward compatibility index (GBC) shown in Equation (1) or Equation (11), and outputs the compatibility index to the score calculation unit 120.

The index number is determined in advance in association with the combination of the coefficients (weights) included in Equation (1). For example, when the compatibility index number “1” corresponds to the BTC, a combination of coefficients “the coefficients a₁₁=b₁₀=b₁₁=1, and other coefficients=0” is previously associated for the compatibility index number “1”. Therefore, when the user designates the compatibility index number “1”, the evaluation index determination unit 110 substitutes the “the coefficients a₁₁=b₁₀=b₁₁=1, and other coefficients=0” to the Equation (1), and generates an evaluation index indicating the BTC score.

The score calculation unit 120 calculates and outputs the compatibility score from the predicted values outputted by the predictors h₁, h₂ using the determined evaluation index. For example, the score calculation unit 120 calculates the values of the four relational expressions CC(h₁,h₂), EC(h₁,h₂), IC₁(h₁,h₂), IC₂(h₁,h₂) by substituting the predicted values outputted by the predictors to Equations (7) to (10), and substitutes the values to the evaluation index such as Equation (6) to calculate and output the GBC score.

The evaluation index determination unit 110 is an example of an index determination means, and the score calculation unit 120 is an example of a calculation means.

[Compatibility Evaluation Processing]

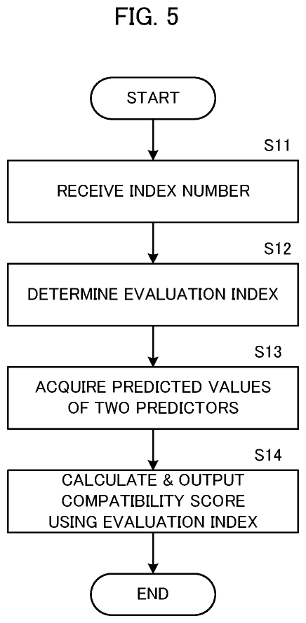

FIG. 5 is a flowchart of compatibility evaluation processing performed by the compatibility evaluation device 100. This processing is realized by the processor 102 shown in FIG. 3, which executes a program prepared in advance and operates as the elements shown in FIG. 4.

First, the compatibility evaluation device 100 receives the designation of the index number by the user (step S11). Next, the evaluation index determination unit 110 determines the evaluation index based on the designated index number (step S12). For example, when the GBC of the first example or the second example described above is used as an evaluation index, the evaluation index determination unit 110 acquires the respective coefficients (weights) corresponding to the index number, and substitutes them to Equation (1) or Equation (11) to determine the evaluation index.

Next, the score calculation unit 120 acquires the predicted values that the the predictors h₁, h₂ outputted for the evaluation data (step S13), and inputs the them to the evaluation index determined in step S12 to calculate and output the compatibility score (the GBC score) (step S14). Thus, the compatibility score indicating the compatibility between the predictor h₁ and the predictor h₂ can be obtained. Then, the processing ends.

[Use Case]

When a plurality of post-update predictors with different hyperparameters or seeds are generated at the time of updating the predictors, the GBC can be used as an index to evaluate their compatibility. By selecting a predictor having a high compatibility with the pre-update predictor from among the plurality of post-update predictors, it is possible to reduce the cost for procedural changes associated with the changed behavior of AI after the update.

In addition, when seasonal changes occur to the data, the GBC can be used to look for the prediction model highly compatible with the current prediction model from among the past prediction models. When there is a past prediction model that is highly accurate and highly compatible with the current prediction model, switching the current prediction model to the prediction model achieves the switching to a prediction model appropriate for the season without the cost of relearning.

Also, when KPI (Key Performance Indicator on the business side) changes during operation of AI, the GBC can be used to construct a compatibility index that emphasizes items that the new KPI emphasizes (e.g., the class that they want to correctly answer) and realize a continuous AI operation.

[Construction of Predictor Using GBC]

In the above example, the GBC is used to evaluate the compatibility of the predictors at the time of updating. Instead, the GBC can be used in training the predictor. In this case, at the time of training the predictor, the GBC is added as a regularization term to the error function which is used in ordinary training. Specifically, the upper bound of the GBC can be constructed by replacing the indication function with the loss function (squared loss or hinge loss) as in the conventional generalized binary classification index. Then, the prediction model is trained so as to minimize the combined error function of the constructed upper bound and the ordinary binary classification. By inputting the pre-update predictors and the additionally collected data, and by using the GBC for the regularization, a new predictor suitable for the target task and having high backward compatibility can be constructed.

### Second Example Embodiment

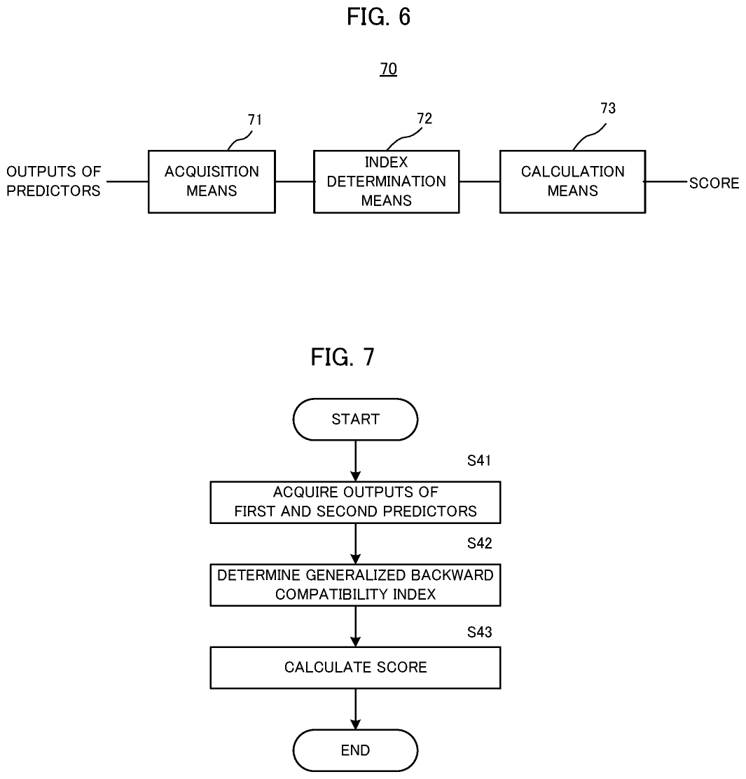

Next, a second example embodiment of the present disclosure will be described. FIG. 6 is a block diagram showing a functional configuration of a compatibility evaluation device 70 according to the second example embodiment. The compatibility evaluation device 70 includes an acquisition means 71, an index determination means 72, and a calculation means 73.

FIG. 7 is a flowchart of processing performed by the compatibility evaluation device 70. The acquisition means 71 acquires outputs of a first predictor and a second predictor for evaluation data (step S41). The index determination means 72 determines a generalized backward compatibility index defined by a combination of a plurality of relational expressions representing relationship between the output of the first predictor and the output of the second predictor (step S42). The calculation means 73 calculates a score indicating compatibility of the first predictor and the second predictor, using the output of the first predictor, the output of the second predictor, and the generalized backward compatibility index (step S43).

According to the compatibility evaluation device 70 of the second example embodiment, it is possible to evaluate the compatibility of the predictors using an appropriate compatibility index according to the task of the predictors.

A part or all of the example embodiments described above may also be described as the following supplementary notes, but not limited thereto.

(Supplementary Note 1)

A compatibility evaluation device comprising:
an acquisition means configured to acquire outputs of a first predictor and a second predictor for evaluation data;
an index determination means configured to determine a generalized backward compatibility index defined by a combination of a plurality of relational expressions representing relationship between the output of the first predictor and the output of the second predictor; and
a calculation means configured to calculate a score indicating compatibility of the first predictor and the second predictor, using the output of the first predictor, the output of the second predictor, and the generalized backward compatibility index.

(Supplementary Note 2)

The compatibility evaluation device according to Supplementary note 1, wherein the generalized backward compatibility index is represented by four arithmetic operations of a plurality of weighted relational expressions.

(Supplementary Note 3)

The compatibility evaluation device according to Supplementary note 2, further comprising a designation means configured to receive a designation of the compatibility index,
wherein the index determination means sets a weight for each of the plurality of relational expressions based on the designation, and determines an evaluation index from the generalized backward compatibility index, and
wherein the calculation means calculates the score using the evaluation index.

(Supplementary Note 4)

The compatibility evaluation device according to any one of Supplementary notes 1 to 3,
wherein the plurality of relational expressions includes:
a first equation indicating a percentage that the output of the first predictor and the output of the second predictor are both correct;
a second equation indicating a percentage that the output of the first predictor and the output of the second predictor are both incorrect;

a third equation indicating a percentage that the output of the first predictor is incorrect and the output of the second predictor is correct; and

a fourth equation indicating a percentage that the output of the first predictor is correct and the output of the second predictor is incorrect.

(Supplementary Note 5)

The compatibility evaluation device according to Supplementary note 4,
wherein the first predictor and the second predictor perform a regression analysis, and
wherein the calculation means regards the output of the first predictor and the second predictor as correct when a difference between an expected value and an actual value corresponding to the expected value is equal to or smaller than a predetermined threshold value, and regards the output of the first predictor and the second predictor as incorrect when the difference is larger than the predetermined threshold value, the expected value being the output of the first predictor and the second predictor.

(Supplementary Note 6)

The compatibility evaluation device according to Supplementary note 1,
wherein the relational expressions indicate a magnitude relationship of the outputs of the first predictor for two evaluation data, and a magnitude relationship of the outputs of the second predictor for the two evaluation data, and
wherein the calculation means calculates, as the score, the expected value with which the magnitude relationship of the outputs of the first predictor and the magnitude relationship of the outputs of the second predictor match.

(Supplementary Note 7)

A compatibility evaluation method comprising:
acquiring outputs of a first predictor and a second predictor for evaluation data;
determining a generalized backward compatibility index defined by a combination of a plurality of relational expressions representing relationship between the output of the first predictor and the output of the second predictor; and
calculating a score indicating compatibility of the first predictor and the second predictor, using the output of the first predictor, the output of the second predictor, and the generalized backward compatibility index.

(Supplementary Note 8)

A recording medium storing a program, the program causing a computer to:
acquire outputs of a first predictor and a second predictor for evaluation data;
determine a generalized backward compatibility index defined by a combination of a plurality of relational expressions representing relationship between the output of the first predictor and the output of the second predictor; and
calculate a score indicating compatibility of the first predictor and the second predictor, using the output of the first predictor, the output of the second predictor, and the generalized backward compatibility index.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

100 Compatibility evaluation device
101 Interface
102 Processor
103 Memory
104 Recording medium
105 Input unit
106 Display unit
110 Evaluation index determination unit
120 Score calculation unit

What is claimed is:

1. A compatibility evaluation device comprising:
a memory configured to store instructions; and
one or more processors configured to execute the instructions to:
acquire outputs of a first predictor and a second predictor for evaluation data;
determine a generalized backward compatibility index defined by a combination of a plurality of relational expressions representing relationship between the output of the first predictor and the output of the second predictor; and
calculate a score indicating compatibility of the first predictor and the second predictor, using the output of the first predictor, the output of the second predictor, and the generalized backward compatibility index.

2. The compatibility evaluation device according to claim 1, wherein the generalized backward compatibility index is represented by four arithmetic operations of a plurality of weighted relational expressions.

3. The compatibility evaluation device according to claim 2,
wherein the one or more processors are further configured to execute the instructions to receive a designation of the compatibility index,
wherein the one or more processors set a weight for each of the plurality of relational expressions based on the designation, and determine an evaluation index from the generalized backward compatibility index, and
wherein the one or more processors calculate the score using the evaluation index.

4. The compatibility evaluation device according to claim 1,
wherein the plurality of relational expressions includes:
a first equation indicating a percentage that the output of the first predictor and the output of the second predictor are both correct;
a second equation indicating a percentage that the output of the first predictor and the output of the second predictor are both incorrect;
a third equation indicating a percentage that the output of the first predictor is incorrect and the output of the second predictor is correct; and
a fourth equation indicating a percentage that the output of the first predictor is correct and the output of the second predictor is incorrect.

5. The compatibility evaluation device according to claim 4,
wherein the first predictor and the second predictor perform a regression analysis, and
wherein the one or more processors regard the output of the first predictor and the second predictor as correct when a difference between an expected value and an actual value corresponding to the expected value is equal to or smaller than a predetermined threshold value, and regard, the output of the first predictor and the second predictor as incorrect when the difference is larger than the predetermined threshold value, the expected value being the output of the first predictor and the second predictor.

6. The compatibility evaluation device according to claim 1,
wherein the relational expressions indicate a magnitude relationship of the outputs of the first predictor for two evaluation data, and a magnitude relationship of the outputs of the second predictor for the two evaluation data, and
wherein the one or more processors calculate, as the score, the expected value with which the magnitude relationship of the outputs of the first predictor and the magnitude relationship of the outputs of the second predictor match.

7. A compatibility evaluation method comprising:
acquiring outputs of a first predictor and a second predictor for evaluation data;
determining a generalized backward compatibility index defined by a combination of a plurality of relational expressions representing relationship between the output of the first predictor and the output of the second predictor; and
calculating a score indicating compatibility of the first predictor and the second predictor, using the output of the first predictor, the output of the second predictor, and the generalized backward compatibility index.

8. A non-transitory computer-readable recording medium storing a program, the program causing a computer to:
acquire outputs of a first predictor and a second predictor for evaluation data;
determine a generalized backward compatibility index defined by a combination of a plurality of relational expressions representing relationship between the output of the first predictor and the output of the second predictor; and
calculate a score indicating compatibility of the first predictor and the second predictor, using the output of the first predictor, the output of the second predictor, and the generalized backward compatibility index.
